(19) United States
(12) Patent Application Publication
(10) Pub. No.: US 2022/0337984 A1
(43) Pub. Date: Oct. 20, 2022

(54) METHOD AND SYSTEM FOR EFFICIENT DELIVERY OF DATA PRODUCT

(71) Applicant: Wejo Limited, Manchester (GB)

(72) Inventors: Stephen Millington, St. Helens (GB); Roger Downing, Chester (GB)

(21) Appl. No.: 17/722,339

(22) Filed: Apr. 16, 2022

Related U.S. Application Data
(60) Provisional application No. 63/176,178, filed on Apr. 16, 2021.

(51) Int. Cl. H04W 4/44; H04W 4/02; G06F 16/2455

(52) U.S. Cl. CPC H04W 4/44; H04W 4/023; G06F 16/2456

(57) ABSTRACT

A data product system and method for efficient delivery of a data product. The method includes: processing geospatial data comprising a plurality of geospatial segments with temporal connected vehicle data to create a time and space varying data processing result; separating a table of reference geometries from the processing result; creating time slice data sets from the processing result; first associating the time slice data sets with the reference geometries to create a first associated set; second associating the first associated set with a measures table representing parameters to be characterized to create a second associated set; pruning null values related to temporal connected vehicle data from the second associated set to produce a result set; outputting the result set; and delivering the result set to a customer, wherein the customer receives an efficiently sized package of the result set.

### TECHNICAL FIELD

This disclosure relates to methods and systems for packaging and delivering data products based on the streaming data, such as data streamed from connected vehicles.

### BACKGROUND

Nowadays, there is a large amount of data streamed from automobiles and other vehicles, and this data is used for various purposes, such as for providing traffic conditions of roads. In many scenarios, vehicles are configured to transmit or stream the same data continuously or periodically to a remote location, such as a remote server. The size of this data may be quite large and may require extensive resources for storage and processing.

### SUMMARY

According to one aspect of the disclosure, there is provided a method for efficient delivery of data product. The method includes: processing geospatial data comprising a plurality of geospatial segments with temporal connected vehicle data to create a time and space varying data processing result; creating a table of reference geometries from the processing result; creating time slice data sets from the processing result; first associating the time slice data sets with the reference geometries to create a first associated set; second associating the first associated set with a measures table representing parameters to be characterized to create a second associated set; pruning null values related to temporal connected vehicle data from the second associated set to produce a result set; outputting the result set; and delivering the result set to a customer, whereby the customer receives an efficiently sized package of the result set.

According to various embodiments, the method may further include any one of the following features or any technically-feasible combination of some or all of the following features:
the second associating results in a subset of geospatial segments with non-matching temporal connected vehicle data, also comprising the step of infilling the nonmatching data with infill values;
the infill values are created with a process comprising: creating a local sample estimate of a measured parameter for each segment; storing each sample estimate relationally with its associated segment; responsive to each sample estimate and data representing the measured parameter creating an estimate characterizing the parameter in a time-limited set; applying a cyclic function to represent the parameter over the limited period of time; and storing parameters for this function against the segment;
the infill values are based on an estimated vehicle density for a particular area;
the infill values are based on an estimated vehicle density for a particular area and period of time;
the first associating step includes performing a cartesian join of the time slice data sets with the table of reference geometries;
the second associating step includes joining a table representing the first associated set with the measures table to create the second associated set; and/or
the method is carried out by a data product system having a memory including computer instructions and at least one processor configured to execute the computer instructions, and wherein, when the at least one processor executes the computer instructions, the data product system carries out the method.

According to one aspect of the disclosure, there is provided a data product system for efficient delivery of a data product comprising: a memory including program instructions and a processor. The processor is configured to execute instructions to at least: ingest temporal connected vehicle data; and process the temporal connected vehicle data at one or more servers to create a data product with geospatial and temporal characteristics. The processing includes: processing geospatial data comprising a plurality of geospatial segments with the temporal connected vehicle data to create a time and space varying data processing result; creating a table of reference geometries from the processing result; creating time slice data sets from the processing result; first associating the time slice data sets with the reference geometries to create a first associated set; second associating the first associated set with a measures table representing parameters to be characterized to create a second associated set; pruning null values related to temporal connected vehicle data from the second associated set to produce a result set; outputting the result set; and delivering the result set to a customer, whereby the customer receives an efficiently sized package of the result set as the data product.

According to various embodiments, the data product system may further include any one of the following features or any technically-feasible combination of some or all of the following features:
the second associating results in a subset of geospatial segments with non-matching temporal connected vehicle data, also comprising the step of infilling the nonmatching data with infill values;
the infill values are created with a process comprising: creating a local sample estimate of a measured parameter for each segment; storing each sample estimate relationally with its associated segment; responsive to each sample estimate and data representing the measured parameter creating an estimate characterizing the parameter in a time-limited set; applying a cyclic function to represent the parameter over the limited period of time; and storing parameters for this function against the segment;
the infill values are based on an estimated vehicle density for a particular area;
the infill values are based on an estimated vehicle density for a particular area and period of time;
the first associating includes performing a cartesian join of the time slice data sets with the table of reference geometries; and/or
the second associating includes joining a table representing the first associated set with the measures table to create the second associated set.

### BRIEF DESCRIPTION OF THE DRAWINGS

Preferred exemplary embodiments will hereinafter be described in conjunction with the appended drawings, wherein like designations denote like elements, and wherein:

FIG. 1 is a system diagram of an environment in which at least one of the various embodiments can be implemented;

FIG. 2 illustrates example logical flow of generating a data product combining geospatial data with temporal data from connected vehicles;

FIG. 3 illustrates example operations for packaging a data product result into a smaller data package for delivery to a customer;

FIG. 4 illustrates example operations to define temporal functions to parameters associated with a geospatial segment; and

FIG. 5 illustrates an example approach for infilling, which may be used to package a data product into a small data package for delivery to a customer.

### DETAILED DESCRIPTION

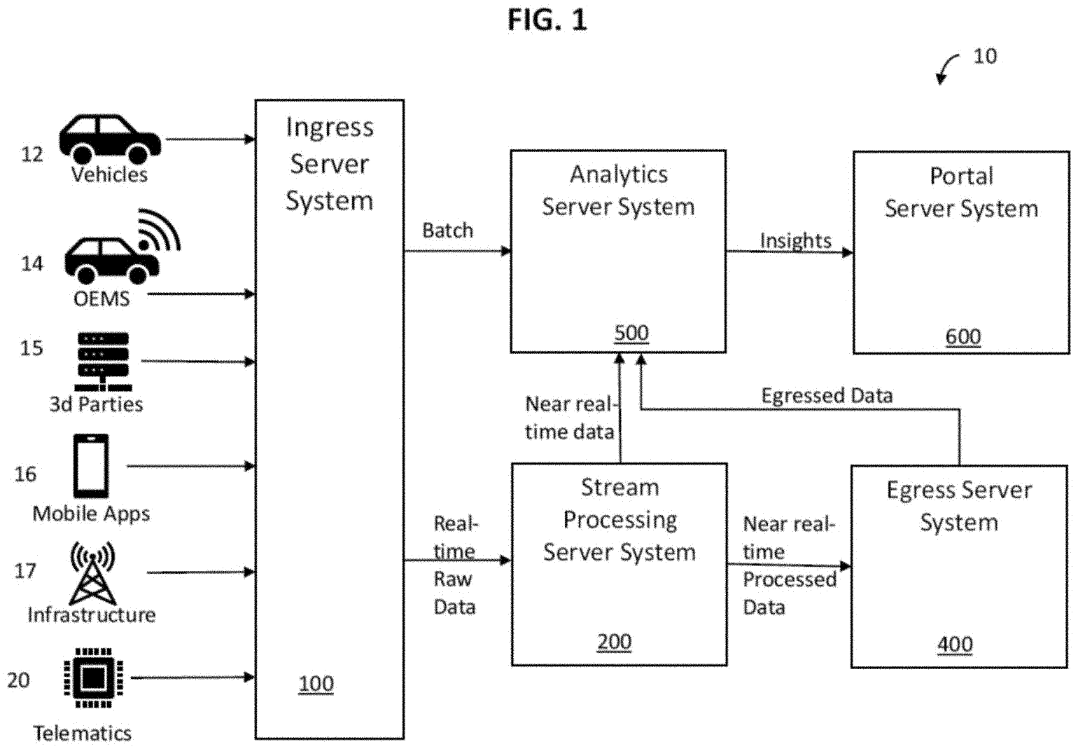

FIG. 1 is a logical architecture of a system 10 for geolocation event processing and analytics in accordance with at least one embodiment. In at least one embodiment, Ingress Server system 100 can be arranged to be in communication with Stream Processing Server system 200 and Analytics Server system 500. The Stream Processing Server system 200 can be arranged to be in communication with Egress Server system 400 and Analytics Server system 500.

The Egress Server system 400 can be configured to be in communication with and provide data output to data customers and consumers. The Egress Server system 400 can also be configured to be in communication with the Stream Processing Server system 200.

The Analytics Server system 500 is configured to be in communication with and accept data from the Ingress Server system 100, the Stream Processing Server system 200, and the Egress Server system 400. The Analytics Server system 500 is configured to be in communication with and output data to a Portal Server system 600.

In at least one embodiment, Ingress Server system 100, Stream Processing Server system 200, Egress Server system 400, Analytics Server system 500, and Portal Server system 600 can each be one or more computers or servers. The various components shown in FIG. 1 can be configured to operate in many manners, of which the following are examples: one or more of Ingress Server system 100, Stream Processing Server system 200, Egress Server system 400, Analytics Server system 500, and Portal Server system 600 can be configured to operate on a single computer, for example a network server computer, or across multiple computers; the system 10 can be configured to run on a web services platform host such as Amazon Web Services (AWS) or Microsoft Azure; the Ingress Server system 100, Stream Processing Server system 200, Egress Server system 400, Analytics Server system 500, and Portal Server system 600 can be hosted on Hosting Servers; and the Ingress Server system 100, Stream Processing Server system 200, Egress Server system 400, Analytics Server system 500, and Portal Server system 600 can be arranged to communicate directly or indirectly over a network to the client computers using one or more direct network paths including Wide Access Networks (WAN) or Local Access Networks (LAN).

The Ingress Server system 100 receives vehicle event data streams, for example as trip data identified from OEMs 14, vehicles 12, third parties 15, mobile apps 16, connected infrastructure 17, telematics service providers 20, and the like. Data from OEMs 14 may come in the form of periodic or streaming connected vehicle data uploaded from OEM vehicles to an OEM data lake or OEM gateway in real time or near-real time (“connected vehicle data streams”). In that case, the ingress server system 100 connects to the OEM data lake or OEM gateway to receive all or a portion of the data from the connected vehicle data streams.

In at least one embodiment, Analytics Server system 500 can be one or more computers arranged to analyze event data. Both real-time and batch data can be passed to the Analytics Server system 500 for processing from other components as described herein. Data provided to the Analytics Server system 500 can include, for example, data from the Ingress Server system 100, the Stream Processing Server system 200, and the Egress Server system 400.

In an embodiment, the Analytics Server system 500 can be configured to accept vehicle event payload and processed information, which can be stored in data stores. The storage may include real-time egressed data from the Egress Server system 400, transformed location data and reject data from the Stream Processing Server system 200, and batch and real-time, raw data from the Ingress Server system 100. Ingressed locations stored in the data store can be output or pulled into the Analytics Server system 500. The Analytics Server system 500 can be configured to process the ingressed location data in the same way as the Stream Processor Server system 200. The Stream Processing Server system 200 can be configured to split the data into a full data set including full data (transformed location data filtered for latency and the rejected latency data) and a data set of transformed location data. The full data set is stored in the data store for access or delivery to the Analytics Server system 500, while the filtered transformed location data is delivered to the Egress Server system 400. Real time filtered data can be processed for reporting in near real time, including reports for performance, Ingress vs. Egress, operational monitoring, and alerts.

The Analytics Server system 500 performs a Journey Segmentation analysis of the event data and builds individual Journeys from Journey segments. A Journey is an individualized vehicle road trip described with geocoded and temporal data. In some examples, Journeys may have starting and/or ending points blurred or omitted for data products provided to customers. As an example, Journey building may occur as described in U.S. Patent Application Publication 2020/0256683 A1, which is hereby incorporated by reference.

In an embodiment, the system 10 can be configured to process vehicle event data to provide enhanced insights and efficient processing. Exemplary processes and systems for processing event data comprise snapping of data points to roads, finding areas of parking related to points of interest, classifying journeys, address matching, traffic volume time series forecasting, determining road co-dependency, identifying traffic congestion, and anomaly detection.

A primary capability of system 10 is the temporal classification of events and measured parameters over the spatial data represented, for example, by geospatial map data. The temporal classification of events and measured parameters may range from computing road densities and computing parking densities to more complex parameters based upon sophisticated learnings and inferences, such as densities of shopping road trips, leisure travels, and others. An inherent nature of temporal classifications and parameters over spatial systems such as maps or map-related parameters is the proliferation of data and the growth of the data set over time. The processes described herein provide gains in the area of spatial-temporal classification and parameter determination in geospatial systems by efficiently packaging large data sets for data products and for delivery to a customer.

A typical city region contains tens of thousands of road segments and so a time varying report of measurements and classifications, if in table form, will contain that many rows of data multiplied by the number of time slices being reported on. For example, a data set characterizing Manhattan traffic for a single day in 15 minute time slices results in more than 1.5 million rows of output. This size is problematic for packaging and delivering data products to customers and gets worse as the area of interest increases.

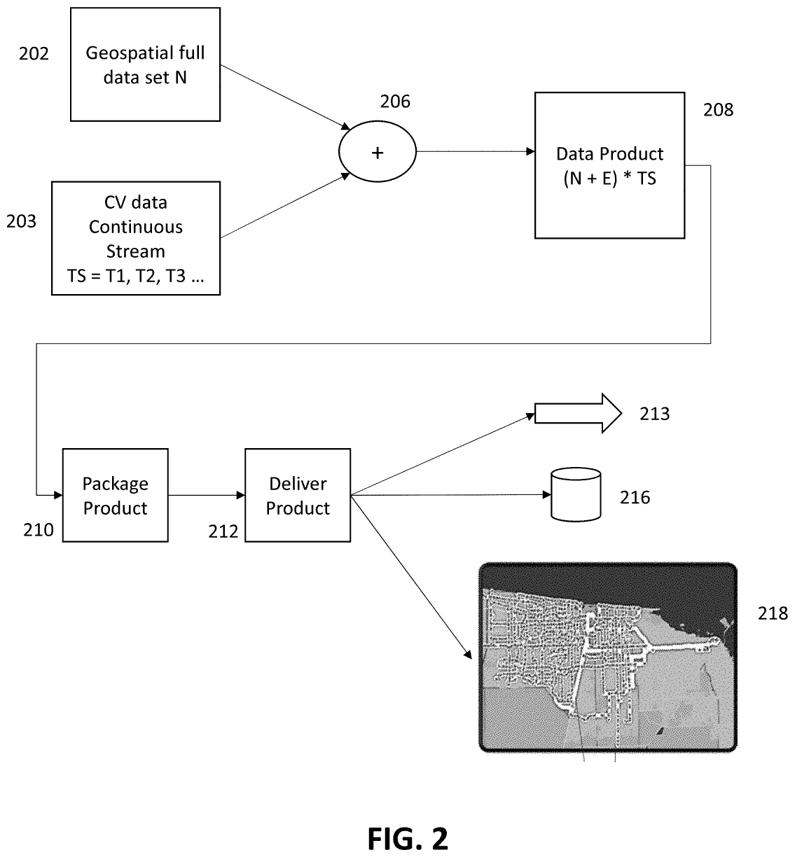

This process can be understood with reference to FIG. 2. Block 202 represents a full geospatial database representing, for example, map data of a desired region. The map data comprises a set of N geospatial segments that together represent a map of the desired region. Block 204 represents a continuous flow of connected vehicle data from a large population of road vehicles in the desired region. Event classifications and measured and computed parameters (based upon temporal connected vehicle data) are stored against each relevant geospatial segment at block 206 and the result is an expansive data product result at block 208 with information describing temporal characteristics of the spatial system represented by the map data as determined from the connected vehicle data and potentially other data sources. In a preferred embodiment, the data product result at block 208 is a relational data base representing time and space varying data, but its size may be a challenge for packaging and delivery to a customer.

A standard practice of relational data base normalization does reduce some of the data product size; for example, details of road geometry for segments do not change and so can be stored once and then referenced against the measures computed for each segment. The measures table is a list of data types measured or analyzed for each geo segment. This table can also be standardized and stored once. This results in a dramatic size saving but is a custom process that ordinarily must be reversed by the data consumer to reproduce a table of geometries with measures attached that can then be loaded into popular software packages such as QGIS or ArcGIS.

There are known geospatial data formats, for example, Spatialite and Geopackage, based around an open-source relational database technology called SQLite. This encapsulates a database holding potentially many relations and other database objects within a single file. Software such as those referred to above can load these newer formats via the embedding of the SQLite libraries, the details of which are transparent to users. Since SQLite is a relational database management system, some more advanced features of databases are readily available. These features include database views. A view allows a virtual table to be created which is populated on access as the result of an embedded query. The use of database view illustrates an example of modifying a known geospatial data format, for example, Geopackage, to define a virtual table relating data base elements. This in turn allows the system 10 to apply processing operations to manipulate the data product result. Taking advantage of the time varying nature of connected vehicle data, along with characteristics of driver behavior and road usage, creates the opportunity to develop a more efficient data product of temporal classifications and parameters of the geospatial system.

In an example using the flexibility these database formats, the system 10 applies operations at block 210 to package the data product result in a smaller dataset without loss of desirable data. This allows operations at block 212 to provide efficient delivery of the data product to customers. The data product can be delivered as online or periodically updated data sets 214, delivered data base products 216, or on-demand graphical user interface products 218.

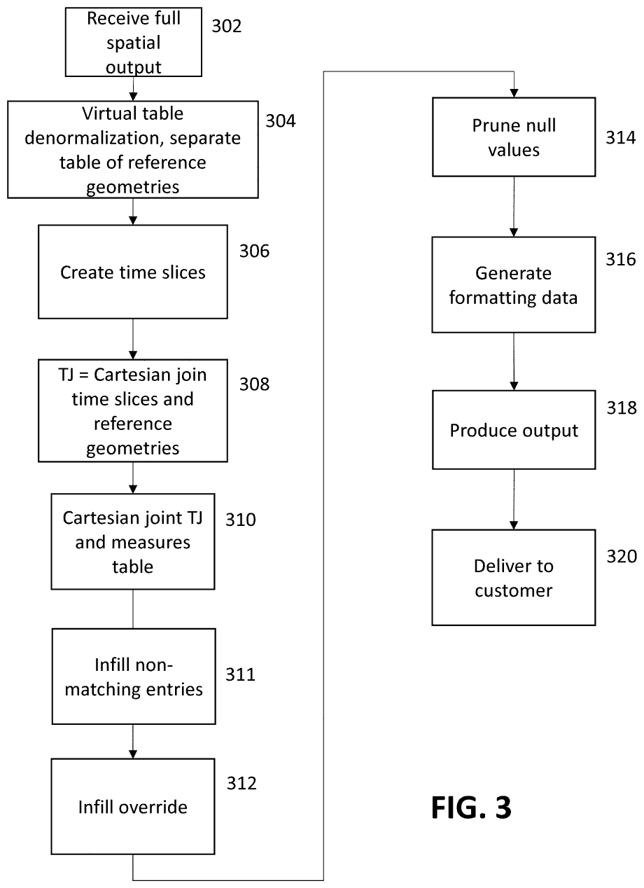

Referring now also to FIG. 3, an example of the system 10 operations to package the data product result begins at block 302 which receives the data product result, for example, from block 208 in FIG. 2. At block 304, system 10 performs operations to denormalize the data product result, for example, through use of a virtual table to separate a table of reference geometries from the data product result.

At block 306, operations divide the data product result into time slice data sets. In any given sample of time slice data from real world processing, there will be significant numbers of combinations of segment and time slice where no measures are produced. The connected vehicles may sample the entire road through a large vehicle population. They reflect behaviors, including quieter times or on quieter roads where it is common for no vehicle movements to be recorded. These quiet roads provide a set of empty measures. For example, if vehicle density is zero then measures of average speed are null and measures of hard braking event counts are zero. This also causes a large amount of duplication in the resulting output that can be removed by normalization.

At block 308, system 10 operations perform a cartesian join of the time slice data sets with the reference geometries, this creates data associations representing all possible combinations of the data sets. The combination at block 308 is referred to as TJ, or the first associated set. At block 310, this combination TJ is then joined against the measures table using a ‘left outer join’ which is to say that all entries from the left-hand side of the join are retained, and any matches from the right-hand side are merged in. During this process, entries without matches are infilled with null entries (block 311). This combination is referred to as the second associated set.

At block 312, system 10 operates to override the infilled values to ensure that the infilled values are the same type as expected, e.g., vehicle density is converted to 0 (zero) when null. At block 314, null entries in the measures table are pruned, or removed entirely, as they are simply generated by the join step. At this point, the operations have created a significantly smaller data package than the data product result at block 208 (FIG. 2) yet still containing all the relevant spatial and temporal information of the data product result.

Though the data has been manipulated and the package reduced in size, it may still be readable as a standard format geospatial data set; though if necessary, missing formatting data may need to be filled in at block 316. For example, in an operation of the above method, software manipulation ensured that the resulting “view” included a unique ID column to maintain compatibility with packages such as ArcGIS Pro which presume existence.

Block 318 represents outputting the data product and block 320 represents delivery of the efficiently sized package to a customer, such as described above with reference to FIG. 2.

In an example, the above process was used to reduce a 4.5 terabyte data product result file to 200 gigabytes, a reduction of 22.5 times.

In the above steps the infilling used null values. It is possible to infill with non-null values to gain even further advantages to system 10 and the packing operations herein. Approaches include infill with average values or interpolated values. Average values here are calculated over similar entries. For example, to produce an average value for time slice from 1600-1615 hours on Wednesday one might take the average of the values for the same time slice across all days of the week. This approach could miss cycles in the relevant data, e.g., traffic volume or density, over different days or other time periods.

Interpolation is another approach where a missing measure is infilled with the average of the values either side of it when ordered by time, for example. This tends to produce values which are more responsive to the ebbs and flows of traffic movement and therefore more representative of ground truth. But this approach does not characterize quiet periods well when there is little information to provide interpolations.

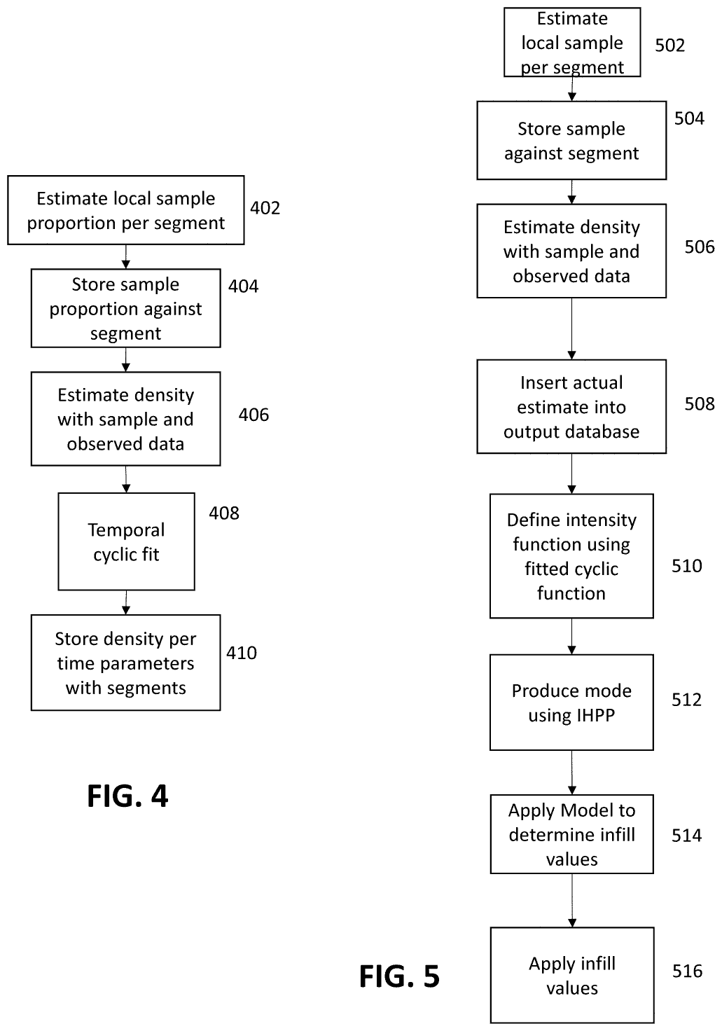

A preferred approach uses fitted models that take into account real-world variability inherent to the data. This allows interpolated values to be generated that are realistic and simple to calculate without reliance on long-term averages or expensive analytical functions such as sliding windows. The process is illustrated with reference to FIG. 4. At block 402, for a given geospatial segment, the system estimates a local sample proportion in the data set relative to actual road population; for example, a vehicle density estimate. At block 404, the sample proportion is stored in association with its respective segment. At block 406, the sample proportion and observed data, e.g., vehicle densities, are used to provide an estimate of actual measurements. At block 408, the operations fit a simple cyclic function over time to represent the desired parameter, e.g., vehicle density, over time. At block 410, the parameters for this function, e.g., vehicle density over time, are stored associated with the segment.

Referring now to FIG. 5, an example of operational steps for applying the infilling into system 10 is illustrated. Blocks 502, 504, and 506 operate the same as blocks 402, 404 and 406 in FIG. 4.

At block 508, system 10 operates to insert the estimated actual density computed at block 506 in the data product result associated with the temporal location of the actual measurement data and the geospatial segment.

At block 510, the system applies a fitted cyclic function similar to block 408 in FIG. 4. At block 512, the operations fit an inhomogeneous poisson point process using the defined intensity function from block 510 to produce a model. At block 514 the system applies the model to determine infill values for empty data points and at block 516, the system applies those infill values in the data set.

Using an inhomogeneous poisson point process with an intensity function permits the modeling of an average number of events occurring over a time period—for example, vehicles driving through a road segment—while allowing for the event rate to vary i.e. rush hours. Poisson process models can be readily calculated on the fly and can be expressed directly in SQL within a generated view once suitable parameters have been estimated by the process creating the database file.

An additional benefit of this approach is the hiding of raw data and the protection that brings regarding data privacy. Users of the resulting output file will see a table of measures of estimated real traffic volumes produced either directly from observation or from the model described with reference to FIG. 5.

Any of the processing or executing instructions that is performed herein may be performed by one or more processors by executing computer instructions stored in memory, such as in one or more memory devices accessibly by the one or more processors. Thus, in some embodiments, said processing or executing instructions may be performed by a single processor and, in other embodiments may be divided among and together performed by a plurality of processors, any or all of which may be co-located or remotely located. Any one or more of the processors discussed herein are electronic processors that may be implemented as any suitable electronic hardware that is capable of processing computer instructions and may be selected based on the application in which it is to be used. Examples of types of electronic processors that may be used include central processing units (CPUs), graphics processing units (GPUs), field-programmable gate arrays (FPGAs), application specific integrated circuits (ASICs), microprocessors, microcontrollers, etc. Any one or more of the computer-readable memory discussed herein may be implemented as any suitable type of non-transitory memory that is capable of storing data or information in a non-volatile manner and in an electronic form so that the stored data or information is consumable by the electronic processor.

The memory may be any a variety of different electronic memory types and may be selected based on the application in which it is to be used. Examples of types of memory that may be used include including magnetic or optical disc drives, ROM (read-only memory), solid-state drives (SSDs) (including other solid-state storage such as solid-state hybrid drives (SSHDs)), other types of flash memory, hard disk drives (HDDs), non-volatile random access memory (NVRAM), etc. It should be appreciated that the computers or servers may include other memory, such as volatile RAM that is used by the electronic processor, and/or may include multiple processors.

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.”

1. A method for efficient delivery of data product, comprising:
processing geospatial data comprising a plurality of geospatial segments with temporal connected vehicle data to create a time and space varying data processing result;
creating a table of reference geometries from the processing result;
creating time slice data sets from the processing result;
first associating the time slice data sets with the reference geometries to create a first associated set;
second associating the first associated set with a measures table representing parameters to be characterized to create a second associated set;
pruning null values related to temporal connected vehicle data from the second associated set to produce a result set;
outputting the result set; and
delivering the result set to a customer, whereby the customer receives an efficiently sized package of the result set.

2. The method of claim 1, wherein the second associating results in a subset of geospatial segments with non-matching temporal connected vehicle data, also comprising the step of infilling the nonmatching data with infill values.

3. The method of claim 2, wherein the infill values are created with a process comprising:
creating a local sample estimate of a measured parameter for each segment;
storing each sample estimate relationally with its associated segment;
responsive to each sample estimate and data representing the measured parameter creating an estimate characterizing the parameter in a time-limited set;
applying a cyclic function to represent the parameter over the limited period of time; and
storing parameters for this function against the segment.

4. The method of claim 3, wherein the infill values are based on an estimated vehicle density for a particular area.

5. The method of claim 4, wherein the infill values are based on an estimated vehicle density for a particular area and period of time.

6. The method of claim 1, wherein the first associating step includes performing a cartesian join of the time slice data sets with the table of reference geometries.

7. The method of claim 1, wherein the second associating step includes joining a table representing the first associated set with the measures table to create the second associated set.

8. The method of claim 1, wherein the method is carried out by a data product system having a memory including computer instructions and at least one processor configured to execute the computer instructions, and wherein, when the at least one processor executes the computer instructions, the data product system carries out the method.

9. A data product system for efficient delivery of a data product comprising: a memory including computer instructions and at least one processor configured to execute the computer instructions to at least:
ingest temporal connected vehicle data; and
process the temporal connected vehicle data at one or more servers to create a data product with geospatial and temporal characteristics, wherein the processing comprises:
processing geospatial data comprising a plurality of geospatial segments with the temporal connected vehicle data to create a time and space varying data processing result;
creating a table of reference geometries from the processing result;
creating time slice data sets from the processing result;
first associating the time slice data sets with the reference geometries to create a first associated set;
second associating the first associated set with a measures table representing parameters to be characterized to create a second associated set;
pruning null values related to temporal connected vehicle data from the second associated set to produce a result set;
outputting the result set; and
delivering the result set to a customer, whereby the customer receives an efficiently sized package of the result set as the data product.

10. The data product system of claim 9, wherein the second associating results in a subset of geospatial segments with non-matching temporal connected vehicle data, also comprising the step of infilling the nonmatching data with infill values.

11. The data product system of claim 10, wherein the infill values are created with a process comprising:
creating a local sample estimate of a measured parameter for each segment;
storing each sample estimate relationally with its associated segment;
responsive to each sample estimate and data representing the measured parameter creating an estimate characterizing the parameter in a time-limited set;
applying a cyclic function to represent the parameter over the limited period of time; and
storing parameters for this function against the segment.

12. The data product system of claim 11, wherein the infill values are based on an estimated vehicle density for a particular area.

13. The data product system of claim 12, wherein the infill values are based on an estimated vehicle density for a particular area and period of time.

14. The data product system of claim 9, wherein the first associating includes performing a cartesian join of the time slice data sets with the table of reference geometries.

15. The data product system of claim 9, wherein the second associating includes joining a table representing the first associated set with the measures table to create the second associated set.
